(19) United States
(12) Patent Application Publication
(10) Pub. No.: US 2017/0127125 A1
(43) Pub. Date: May 4, 2017

(54) System, Apparatus and Method for Distribution of a Signal on a Single Cable

(71) Applicant: THOMSON LICENSING, Issy les Moulineaux (FR)

(72) Inventors: Mark Anderson, Indianapolis, IN (US); Barry Weber, Carmel, IN (US)

(21) Appl. No.: 15/315,392

(22) PCT Filed: Jun. 15, 2015
(86) PCT No.: PCT/US15/35774

§ 371 Date: Dec. 1, 2016

Related U.S. Application Data
(60) Provisional application No. 62/012,487, filed on Jun. 16, 2014.

(51) Int. Cl. H04N 21/436; H04N 21/462; H04N 21/442; H04N 21/643; H04N 21/61

(52) U.S. Cl. CPC H04N 21/43615; H04N 21/64322; H04N 21/6118; H04N 21/44227; H04N 21/4622

(57) ABSTRACT

A system, apparatus and method for distribution of a signal on a single cable are provided. The present disclosure provides for receiving a signal from a provider, determining whether the signal is to be delivered using a first signal format or a second signal format, providing the signal to a second device over the co-axial cable in the first signal format if it is determined that the signal is to be delivered using the first signal format, and providing the signal over the co-axial cable in the second signal format if it is determined that the signal is to be delivered using the second signal format. The first signal format may include at least one of an analog signal and an RF modulated analog signal. The second signal format may include at least one of a digital signal, an RF modulated IP signal and a MoCA signal.

### CROSS-REFERENCE TO RELATED APPLICATION

This application claims the benefit of U.S. Provisional Application Ser. No. 62/012,487, filed on Jun. 16, 2014, which is incorporated by reference herein its entirety.

### TECHNICAL FIELD

The present disclosure generally relates to digital content systems and methods for controlling components of such systems, and more particularly, to a system, apparatus and method for distribution of a Multimedia over Cable Alliance (MoCA) or radio frequency (RF) modulated audio/video signal on a single cable.

### BACKGROUND

Home entertainment systems, including television, media centers and mobile devices, are converging with the Internet and providing access to a large number of available sources of content, such as video, movies, television (TV) programs, music, etc. To provide this large volume of content to a plurality of users, for example, in a residence, multiple devices such as televisions may be provided in a single location. Each television may be provided in a different room of the residence so that different users may view different content such as movies, TV programs, etc. Each television will require a set top box to receive signals from a television service provider, such as satellite and cable television providers. Typical set top boxes use a channel ¾ RF modulator or agile modulator to drive an analog TV on a coaxial (coax) cable. Typically, one TV per modulated output has been the standard.

Advanced set top boxes have the capability to provide an analog signal to a remote located analog television or to provide a digital signal to a remote client set top box for display on a digital signal ready television. During initial installation or configuration, only the capability to provide an analog signal to an analog television may be used or necessary. At a later point, the user may upgrade from an analog television to a digital signal ready television. However, either a new cable or additional network cabling changes may be necessary to switch from providing the analog signal to providing the digital signal, requiring a service call and increased costs to the service provider. Further, problems may exist in providing the analog signal, which may use any one or more of the existing broadcast channel frequencies (e.g., channel 3 and channel 4), and the digital signal simultaneously on the same cable.

Therefore, a need exists for techniques for providing content from a set top box to a remote signal display location in more than one signal format utilizing a single existing cable.

### SUMMARY

According to one aspect of the present disclosure, a method is provided including, inter alia, receiving a signal from a media service provider, determining whether the signal is to be delivered using a first signal format or a second signal format through a co-axial cable, providing the signal to a second device over the co-axial cable in the first format if it is determined that the signal is to be delivered using the first signal format, and providing the signal to the second device over the co-axial cable in the second signal format if it is determined that the signal is to be delivered using the second signal format.

According to another aspect of the present disclosure, an apparatus is provided including, inter alia, a signal interface that receives a signal from a media service provider, a controller coupled to the first interface, the controller determining whether the signal is to be delivered using a first signal format or a second signal format, and a switch coupled to the controller, the switch providing the signal to a second device in one of the first signal format and the second signal format based on the determination by the controller.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

### BRIEF DESCRIPTION OF THE DRAWINGS

These, and other aspects, features and advantages of the present disclosure will be described or become apparent from the following description of the embodiments, which is to be read in connection with the accompanying drawings.

In the drawings, wherein like reference numerals denote similar elements throughout the views:

FIG. 1 is a block diagram of an exemplary system for receiving signals in accordance with the present disclosure;

FIG. 2A is a perspective view of an exemplary remote controller in accordance with an embodiment of the present disclosure;

FIG. 2B is a perspective view of a touch panel or interface in accordance with the present disclosure;

FIG. 3 illustrates an exemplary embodiment of a system for receiving signals where a master or gateway set top box provides content to two display devices in accordance with the present disclosure;

FIG. 4 illustrates an exemplary embodiment of a system for receiving signals and providing content to at least two set top boxes in accordance with the present disclosure;

FIG. 5 illustrates an exemplary embodiment of a system for receiving signals where a master or gateway set top box provides content to a client set top box in accordance with the present disclosure;

FIG. 6 is a block diagram of circuitry for distribution of MoCA or RF modulated audio/video signals on a single cable in accordance with the present disclosure;

FIG. 7 is a flowchart of an exemplary method for detecting a client device on a network in accordance with an embodiment of the present disclosure;

FIG. 8 is a flowchart of an exemplary method for distribution of MoCA or RF modulated audio/video signals on a single cable in accordance with an embodiment of the present disclosure; and

FIG. 9 is a flowchart of an exemplary method for distribution of MoCA or RF modulated audio/video signals on a single cable in accordance with another embodiment of the present disclosure.

It should be understood that the drawing(s) is for purposes of illustrating the concepts of the disclosure and is not necessarily the only possible configuration for illustrating the disclosure.

### DESCRIPTION OF EMBODIMENTS

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

A system, apparatus and method for distribution of MoCA or RF modulated audio/video signals on a single cable are provided. The present disclosure relates to the operation in a home network system for distributing media content received on a central device to one or more client devices over a cable using one of two possible signal formats. In a particular embodiment, a gateway device receives a satellite signal and is capable of distributing the signal either as a modulated analog or digital TV channel (e.g., channel ¾) or as a MoCA signal on a coaxial cable to one or more client boxes. Either or both of the gateway device and thin client device (both set top boxes with different features) may contain switching circuitry (either manual or automatic) that determines whether the signal is to be sent or has been received using one of the two formats. The systems, apparatuses and methods of the present disclosure provide the ability to start a customer with a low cost solution for a second television display (possibly with no additional client set top box) and then provide an upgrade path to a better solution using the client set top box without having to perform a “truck roll” to the user's home.

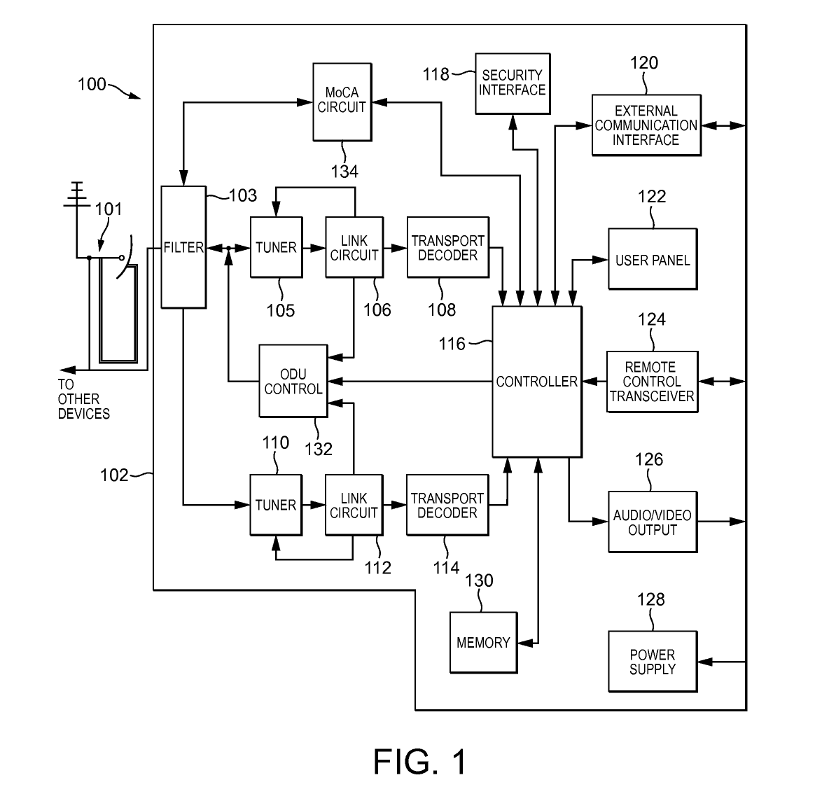

Turning now to the drawings and referring initially to FIG. 1, an exemplary embodiment of a system 100 for receiving signals and providing content to a user using aspects of the present disclosure is shown. System 100 primarily receives signals from one or more satellites as well as multiple television broadcast transmission sites. The signals are provided by one or more service providers and represent broadcast audio and video programs and content. System 100 is described as including components that reside both inside and outside a user's premises. It is important to note that one or more components in system 100 may be moved from inside to outside the premises. Further, one or more components may be integrated with a display device, such as a television or display monitor (not shown). In either case, several components and interconnections necessary for complete operation of system 100 are not shown in the interest of conciseness, as the components not shown are well known to those skilled in the art.

An outdoor unit (ODU) 101 receives signals from satellites and from terrestrial transmission towers through an over the air and/or near earth orbit communications link. ODU 101 is connected to set top box 102. Within set top box 102, the input is connected to filter 103. Filter 103 connects to three signal processing paths. A first path includes tuner 105, link circuit 106, and transport decoder 108 connected together serially. A second path includes tuner 110, link circuit 112, and transport decoder 114 connected together serially. A third path includes MoCA circuit 134 which further connects to controller 116. The outputs of transport decoder 108 and transport decoder 114 each connect to controller 116. Controller 116 connects to security interface 118, external communication interface 120, user panel 122, remote control transceiver 124, audio/video output 126, power supply 128, memory 130, and ODU control 132. External communication interface 120, remote control transceiver 124, audio/video output 126, and power supply 128 provide external interfaces for the set top box 102. ODU control 132 also connects to the filter 103.

Satellite signal streams, each containing a plurality of channels, are received by ODU 101. ODU 101 includes a dish for capturing and focusing the propagated radio wave from the atmosphere onto one or more antennas contained within a structure known as a low noise block converter (LNB). ODU 101 may be configured to receive the signal streams from satellite transponders located on one or more satellites. In a preferred embodiment, two sets of sixteen channels are received by ODU 101, and converted, using one or more LNBs to a frequency range of 950 Megahertz (MHz) to 2,150 MHz, referred to as L-band. ODU 101 also includes a terrestrial antenna for receiving over the air broadcasts. In a preferred embodiment, ODU 101 includes a multiple element antenna array for receiving ISDBT signals in the frequency range from 170 MHz to 800 MHz.

ODU 101 provides a converted signal stream to the set top box 102 through radio frequency (RF) co-axial cable. The converted signal stream is provided to filter 103. In a preferred embodiment, filter 103 operates as a multiplex filter with up to three separate filter sections or interfaces. The frequency response properties of filter 103 may include a separate highpass filter and lowpass filter such that the frequency passbands of each do not overlap. The arrangement, often referred to as a diplexer or diplex filter, allows for a separation, through signal filtering, of the incoming satellite signal and/or MoCA signal from the terrestrial signal and/or MoCA signal. In a preferred embodiment, the low pass filter frequency response pass band ends at a frequency below 900 MHz. The low pass filter portion allows a MoCA signal in a frequency range from 475 MHz to 625 MHz as well as a terrestrial signal in the frequency range from 170 MHz to 800 MHz to pass through to subsequent blocks while attenuating, or not passing through, a satellite signal in a frequency range from 950 MHz to 2,150 MHz. The high pass filter portion operates in an opposite manner passing the MoCA signal, in the frequency range around 1100 MHz, along with the satellite signal through and attenuating cable or terrestrial broadcast signal. The high pass filter portion may also filter any electrical supply or communication signals provided to the ODU 101. An additional bandpass filter circuit may be provided to further process MoCA signals and provide the signals as an output to a home MoCA network or for processing in set top box 102. Other embodiments may be possible and some of these embodiments are described in further detail below. Filter 103 may also include surge or transient voltage protection devices.

The output signal from the high pass filter portion of filter 103 is provided to a first signal path containing a tuner 105, a link circuit 106, and a transport decoder 108 connected in a serial fashion. The output signal from the low pass filter portion of the filter 103 is provided to a second signal path. The second signal path also contains a tuner 110, a link circuit 112, and a transport decoder 114 connected in a serial fashion. Each processing path may perform similar processing on the filtered signal streams, the processing being specific to the transmission protocol used.

Tuner 105 processes the split signal stream by selecting or tuning one of the channels provided from a satellite service provider in the highpass filtered signal stream to produce one or more baseband signals. Tuner 105 contains circuits (e.g., amplifiers, filters, mixers, and oscillators) for amplifying, filtering and frequency converting the satellite signal stream. Tuner 105 typically is controlled or adjusted by link circuit 106. Alternately, tuner 105 may be controlled by another controller, such as controller 116, which will be described later. The control commands include commands for changing the frequency of an oscillator used with a mixer in tuner 105 to perform the frequency conversion.

Tuner 110 processes the lowpass filtered signal stream by selecting or tuning one of the terrestrial or cable broadcast channels in the split signal stream to produce one or more baseband signals. Tuner 110 contains circuits (e.g., amplifiers, filters, mixers, and oscillators) for amplifying, filtering and frequency converting the signal stream. Tuner 110 may controlled or adjusted in a manner similar to that described earlier for tuner 105.

Typically the baseband signals at the output of tuner 105 or tuner 110 may collectively be referred to as the desired received signal and represent one satellite channel selected out of a group of channels that were received as the input signal stream. Although the signal is described as a baseband signal, this signal may actually be positioned at a frequency that is only near to baseband.

The one or more baseband signals from the satellite service provider are provided to link circuit 106 through tuner 105. Link circuit 106 typically contains the processing circuits needed to convert the one or more baseband signals into a digital signal for demodulation by the remaining circuitry of link circuit 106. In one embodiment the digital signal may represent a digital version of the one or more baseband signals. In another embodiment the digital signal may represent the vector form of the one or more baseband signals. Link circuit 106 also demodulates and performs error correction on the digital signal from the satellite service provider to produce a transport signal. The transport signal may represent a data stream for one program, often referred to as a single program transport streams (SPTS), or it may represent multiple program streams multiplexed together, referred to as a multiple program transport stream (MPTS).

The one or more baseband signals from the broadcast service provider are provided to link circuit 112 through tuner 110. Link circuit 112 typically contains the processing circuits needed to convert the one or more baseband signals into a digital signal for demodulation by the remaining circuitry of link circuit 112 in a manner similar to link circuit 106 described earlier. Link circuit 112 also demodulates, performs broadcast channel equalization error correction on the digital signal from the broadcast service provider to produce a transport signal. As described earlier, the transport signal may represent a data stream for one program or it may represent multiple program streams multiplexed together.

The transport signal from link circuit 106 is provided to transport decoder 108. Transport decoder 108 typically separates the transport signal, which is provided as either a SPTS or MPTS, into individual program streams and control signals. Transport decoder 108 also decodes the program streams, and creates audio and video signals from these decoded program streams. In one embodiment, transport decoder 108 is directed by user inputs or through a controller such as controller 116 to decode only the one program stream that has been selected by a user and create only one audio and video signal corresponding to this one decoded program stream. In another embodiment, transport decoder 108 may be directed to decode all of the available program streams and then create one more audio and video signals depending on user request.

The transport signal from link circuit 112 is similarly provided to transport decoder 114. Transport decoder 114 decodes the program streams, and creates audio and video signals from these decoded program streams as directed by user inputs or a controller in a manner similar to that described earlier for transport decoder 108.

The audio and video signals, along with any necessary control signals, from both transport decoder 108 and transport decoder 114 are provided to controller 116. Controller 116 manages the routing and interfacing of the audio, video, and control signals and, further, controls various functions within set top box 102. For example, the audio and video signals from transport decoder 108 may be routed through controller 116 to an audio/video (A/V) output 126. AN output 126 supplies the audio and video signals from set top box 102 for use by external devices (e.g., televisions, display monitors, and computers). It is to be appreciated that the audio/video output 126 may include more than one physical output connector, e.g., an analog output, a high definition multimedia interface (HDMI) output, etc. Also, the audio and video signals from transport decoder 114 may be routed through controller 116 to memory block 130 for recording and storage.

Memory block 130 may contain several forms of memory including one or more large capacity integrated electronic memories, such as static random access memory (SRAM), dynamic RAM (DRAM), or hard storage media, such as a hard disk drive or an interchangeable optical disk storage system (e.g., compact disk drive or digital video disk drive). Memory block 130 may include a memory section for storage of instructions and data used by controller 116 as well as a memory section for audio and video signal storage. Controller 116 may also allow storage of signals in memory block 130 in an alternate form (e.g., an MPTS or SPTS from transport decoder 108 or transport decoder 114).

Controller 116 is also connected to an external communications interface 120. External communication interface 120 may provide signals for establishing billing and use of the service provider content. External communications interface 120 may include a phone modem for providing phone connection to a service provider. External communications interface 120 may also include an interface for connection to an Ethernet network and/or to home wireless communications network. The Ethernet network and/or home wireless network may be used for communication data, audio, and/or video signals and content to and from other devices connected to the Ethernet network and/or home wireless network (e.g., other media devices in a home).

Controller 116 also connects to a security interface 118 for communicating signals that manage and authorize use of the audio/video signals and for preventing unauthorized use. Security interface 118 may include a removable security device, such as a smart card. User control is accomplished through user panel 122, for providing a direct input of user commands to control the set top box and remote control receiver 124, for receiving commands from an external remote control device. Although not shown, controller 116 may also connect to the tuners 105, 110, link circuits 106, 112, and transport decoders 108, 114 to provide initialization and set-up information in addition to passing control information between the blocks. Finally, power supply 128 typically connects to all of the blocks in set top box 102 and supplies the power to those blocks as well as providing power to any of the elements needing power externally, such as the ODU 101.

Controller 116 also controls ODU control 132. ODU control 132 provides signaling and power supply electrical power back to the ODU 101 through filter 103. ODU control 132 provides these signals and power onto the co-axial cable(s) running between ODU 101 and set top box 102. In one embodiment, the ODU control 132 receives input control signals from controller 116 and provides different DC voltage levels to specific portions of the ODU 101 to provide a certain signal stream containing a set of programs or content to filter 103 and further to tuner 105 and tuner 110. In another embodiment, the ODU control 132 receives inputs from controller 116 and also from link circuit 106 and link circuit 112 and provides DC voltage levels and a separate tuning control signal to ODU 101 using low frequency carrier based frequency shift keying modulation. Controller 116 also may send control commands to disable ODU controller 130 from providing either direct current (DC) voltages or control signals to ODU 101.

MoCA circuit 134 amplifies and processes the MoCA signal both for reception and transmission. As described above the MoCA interface permits communications of audio and video signals in a home network and may operate bi-directionally. MoCA circuit 134 includes a low noise amplifier for improving reception performance of a MoCA signal received by signal receiving device 100 from another network connected device. The received and amplified signal is tuned, demodulated, and decoded. The decoded signal may be provided to a number of other circuits, including audio and video outputs as well as a mass storage device (e.g., hard disk drive, optical drive, and the like), not shown. Additionally, MoCA circuit 134 generates and formats the MoCA transmit signal using audio and video content available in signal receiving device, including content received from the input (e.g., satellite signal) and content from the mass storage device. MoCA circuit 134 also includes a power amplifier for increasing the transmitted signal level of the MoCA signal sent by signal receiving device 100 to another network connected device. Adjustment of the receive signal amplification as well as the transmit signal amplification in MoCA circuit 134 may be controlled by controller 116.

It should be appreciated by one skilled in the art that the blocks described inside set top box 102 have important interrelations, and some blocks may be combined and/or rearranged and still provide the same basic overall functionality. For example, transport decoder 108 and transport decoder 114 may be combined and further integrated along with some or all of the functions of controller 116 into a System on a Chip (SoC) that operates as the main controller for set top box 102. Further, control of various functions may be distributed or allocated based on specific design applications and requirements. As an example, link circuit 106 may provide control signals to ODU control 132 and no connection may exist between link circuit 112 and ODU control 132.

Further, it should be appreciated although ODU 101 includes both a dish and LNB for use with satellite signals and a terrestrial antenna, other embodiments may use separate structures. In some embodiments, the satellite dish and LNB and included in one structure and the terrestrial antenna is part of a second structure. The outputs of both satellite dish/LNB structure and terrestrial antenna are combined using a signal combining circuit and provided to set top box 102.

Although set top box 102 is described above as receiving a single converted signal stream, set top box 102 may also be configured to receive two or more separate converted signal streams supplied by ODU 101 in some modes of operation. Operation in these modes may include additional components including switches and/or further tuning and signal receiving components, not shown. Further, set top box 102 may be designed to operate only on a home network using the Ethernet or home wireless network interfaces described above. In this case, the elements associated with operation in a MoCA network may be removed from set top box 102.

To operate effectively, the set top box 102 of the present disclosure employs an input device such as a remote control device to input commands, make selections, etc. Alternatively, a mouse device, a remote control with navigation features, or gesture based remote control may also be used, as will be described below.

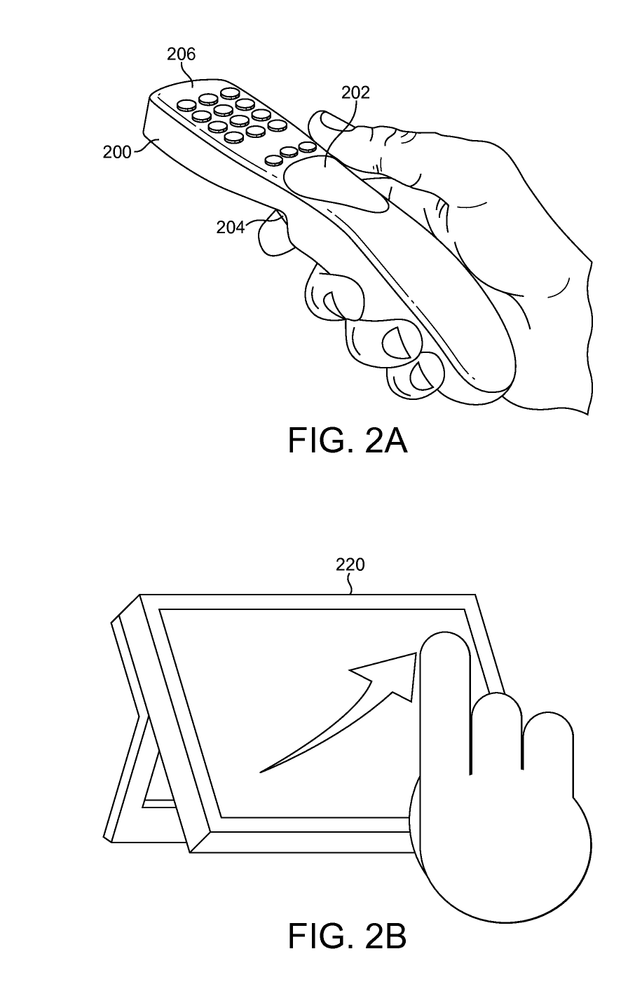

In one embodiment, the input device is a remote control device, with a form of motion detection, such as a gyroscope or accelerometer, which allows the user to move a cursor freely about a screen or display. An exemplary hand-held angle-sensing remote control 200 is illustrated in FIG. 2A. Remote controller 200 includes a thumb button 202, positioned on the top side of controller 200 so as to be selectively activated by a user's thumb. Activation of thumb button 202 will also be referred to as a “click,” a command often associated with activation or launch of a selected function. Controller 200 further includes a trigger button 204, positioned on the bottom side of controller 200 so as to be selectively activated by a user's index (or “trigger”) finger. Activation of trigger button 204 will also be referred to as a “trigger,” and angular movement (i.e. pitch, yaw and/or roll) of the controller 200 while the trigger is depressed will be referred to as a “trigger-drag.” A trigger-drag command is often associated with movement of a cursor, virtual cursor or other indication of the user's interactive position on the display, such as a change of state (i.e., a highlighted or outlined cell), and is commonly used to navigate in and select entries from the interactive display. Additionally, a plurality of buttons 206 are provided for entering numbers and/or letters. In one embodiment, the plurality of buttons 206 are configured similar to a telephone-type keypad.

The use of a hand-held angle-sensing remote controller provides for a number of types of user interaction. When using an angle-sensing controller, changes in yaw map to left-and-right motions, changes in pitch map to up-and-down motions and changes in roll map to rotational motions along a longitudinal axis of the controller. These inputs are used to define gestures and the gestures, in turn, define specific contextual commands. As such, a combination of yaw and pitch can be used to define any 2-dimensional motion, such as a diagonal, and a combination of yaw, pitch and roll can be used to define any 3-dimensional motion, such as a swing.

To further enhance the user experience and to facilitate the display of, and navigation around, a database such as a movie library, a touch panel device 220 may be interfaced to the set top box 102 as shown in FIG. 2B. The touch panel device 220 allows operation of the set top box 102 based on hand movements, or gestures, and actions translated through the panel into commands for the receiving device. In one embodiment, the touch panel 220 may simply serve as a navigational tool to navigate a collection of items such as movie posters. In other embodiments, the touch panel 220 will additionally serve as the display device allowing the user to more directly interact with the navigation through the display of content.

It is to be appreciated that at least some of the components described above in relation to FIGS. 1-2 will form an apparatus and/or system for distribution of MoCA or RF modulated audio/video signals on a single cable.

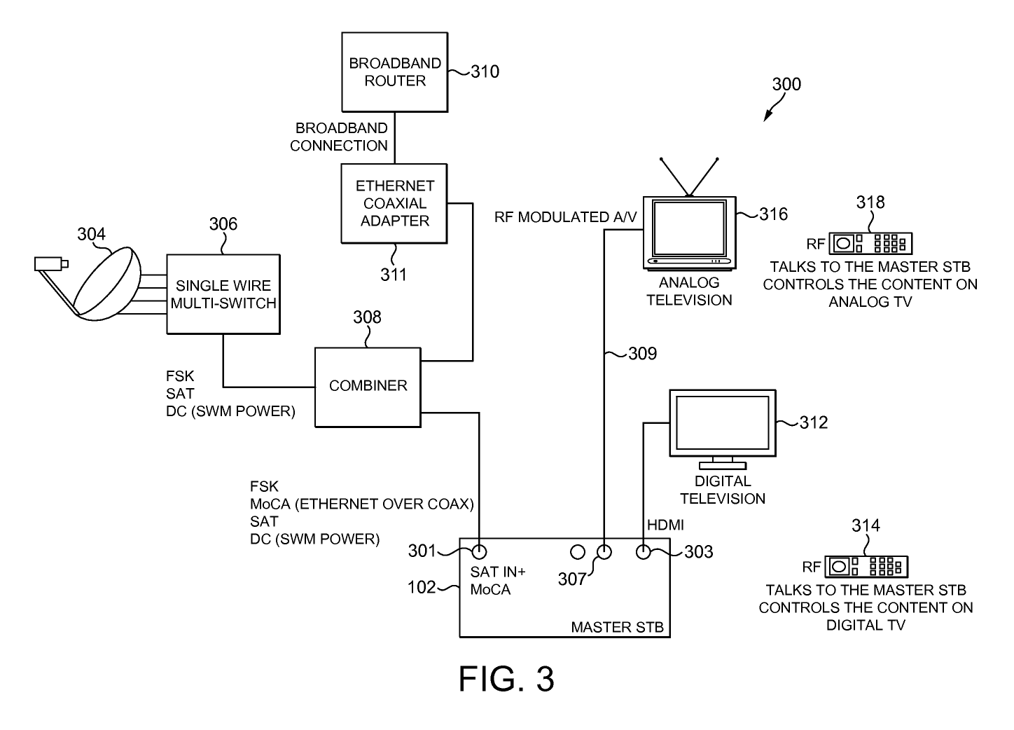

Referring to FIG. 3, an exemplary embodiment of a system 300 for receiving signals where a master or gateway set top box provides content to at least two display devices in accordance with the present disclosure is illustrated. In FIG. 3, an outdoor unit (ODU) 304 receives a signal and provides the signal to a single wire multi-switch 306 for selecting which of a plurality of transponders to be used and for outputting a satellite source signal to combiner 308. A router 310 receives broadband communication signals and transmits the broadband communication signals to the combiner 308 via a Ethernet coaxial adapter 311. The combiner 308 receives the satellite source and broadband communication signals and combines the inputs to generate a MoCA compliant signal which is fed to a Sat In/MoCA connector 301 of the set top box 102. As described above in relation to FIG. 1, the set top box 102 provides content to various devices. FIG. 3 illustrates a two room viewing installation wherein the broadcast signal is provided by a satellite provider; however, other television service providers may be employed, e.g., a cable television service provider, and more than two television may be utilized.

In FIG. 3, set top box 102 is configured as a master server or gateway. The set top box 102 is coupled to display device 312, e.g., a high definition television, via an audio/video output 303, e.g., a HDMI output. Remote control device 314 is paired to set top box 102 and controls the content displayed on display device 312. Set top box 102 further includes an analog output 307 which is coupled to a second display device 316, e.g., an analog television. The set top box 102 generates a user experience and/or audio/video programming, converts it to an analog format and distributes it to the analog output 307 via an RF modulated analog signal. A second remote control device 318 is paired to the set top box 102 for controlling the content displayed on the second display device 316. It is to be appreciated that the remote control devices 314, 318 are configured to send commands to the set top box 102 for controlling operation thereof, for example, changing a channel of programming being displayed, activating a digital video recorder (DVR) function, navigating a library of stored content, etc. The remote control devices may be configured in the form factor described above in relation to FIGS. 2A and 2B, although other form factors are contemplated for use by the present disclosure. Additionally, the remote control devices 314, 318 use radio frequency (RF) transmissions operating under one or more standards including, but not limited to, Bluetooth Audio/Video Remote Control Profile (AVRCP), ZigBee Radio Frequency for Consumer Electronics (RF4CE), Z-Wave, etc. However, other wireless communication protocols may be used such as WiFi, infrared, etc.

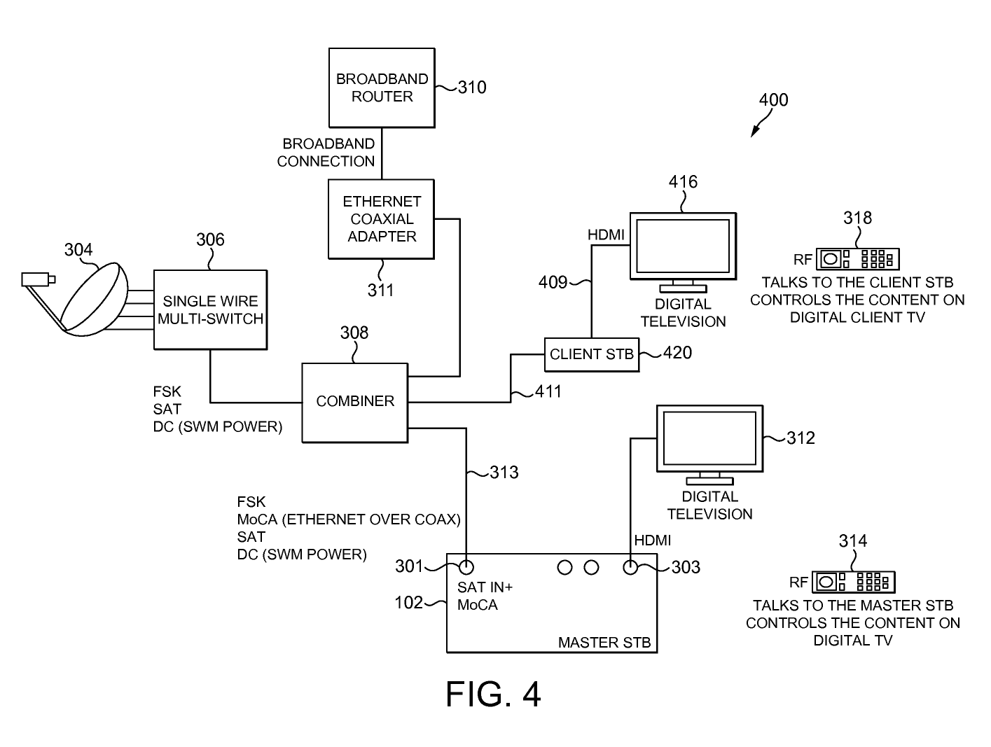

FIG. 4 represents the situation where a user of the system 300 in FIG. 3 upgrades the analog television 316 to a digital television 416. In the system 400, a digital client set top box 420 is provided to control operation of the digital television 416 and provide content to the digital television 416 via digital output 409, e.g., a HDMI output. However, a new connection line 411, e.g., a coax cable, is now required to be installed from the location of the combiner 308 to the location of the client set top box 420. The installation of the new line 411 requires service personnel from the television service provider to travel to the residence of the user to perform this task (i.e., a “truck roll”), resulting in increased cost to the service provider and/or end user.

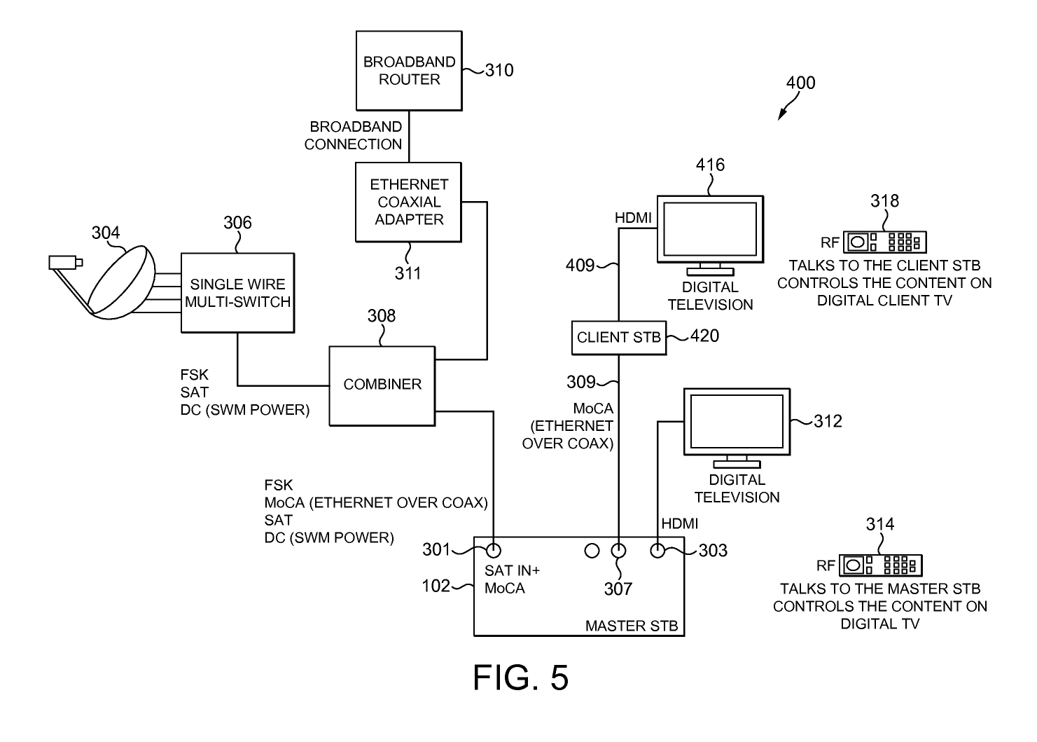

Referring to FIG. 5, a system 500 in accordance with the teachings of the present disclosure enables the master set top box 102 to provide content to the client set top box 420 over the existing coax cable 309 avoiding the need to install new cabling. In system 500, the client set top box 420 is coupled to the master or gateway set top box 102 via line 309 where the master set top box 102 provides content by a digital signal or a multimedia over cable alliance signal, i.e., a MoCA compliant transmission signal, instead of an RF modulated analog signal. Components of system 500 that are labeled the same as components of system 300 perform substantially the same function and their description will not be repeated for conciseness.

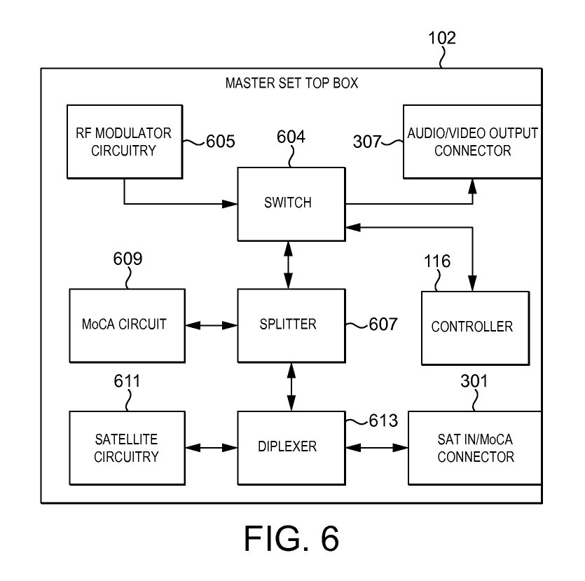

Referring to FIG. 6, circuitry of the master set top box 102 to perform the teachings in accordance with the present disclosure is illustrated. It is to be appreciated that some of the components or modules described in relation to FIG. 1 are shown in FIG. 3 in one form or another. For example, MoCA circuit 609 functions substantially similar to MoCA circuit 134, satellite circuitry 611 functions substantially similar to the combination of tuner 110 and link circuit 112 and diplexer 613 functions substantially similar to filter 103. The diplexer 613 is coupled to Sat In/MoCA connector 301, which may be shared by the satellite signal/MoCA signal creating a first “network” over medium 313. It is further to be appreciated that diplexer 613 that passes the MoCA signal also has to pass the modulated analog signal, e.g., the diplexer 613 may be set at a frequency of channel 3 or 4 or other frequencies which are usually below the frequency range for the satellite signal. In other words, the second signal format (i.e., a digital signal) is in a frequency range that is different than the first signal format (i.e., an analog signal). In other embodiments, the digital signal, e.g., the MoCA signal, may be in the same frequency ranged at the RF modulated analog signal.

In addition to the circuits and modules described above in relation to FIG. 1, the master set top box 102 includes a switch 604 configured to switch between receiving a signal of a first format and a signal of a second format and outputting or delivering the received signal via an audio/video output connector 307 over a single medium, e.g., a coax cable. RF modulator circuitry 605 provides the signal of the first format, e.g., an analog signal format or a digital signal format on at least one of a broadcast channel and a broadcast channel ¾. The MoCA circuit 609 provides the second signal format, e.g., a multimedia over cable alliance signal, via splitter 607 to the switch 604. It is to be appreciated that the second signal format may also include an RF modulated Internet Protocol (IP) signal.

The audio/video output connector 307 may be shared by either the MoCA or RF modulator signal. The audio/video output connector 307 provides a second “network” for distributing A/V signal around the home (either as RF modulated (¾) signal or as MoCA signal). In other words, a MoCA signal may be distributed throughout the home on the same cable as the satellite signal, e.g., the first network via connector 301 and medium 313. The MoCA signal may alternatively or in addition, be distributed on the second network instead of the RF modulated analog signal, e.g., via connector 307 and medium 309.

For purposes of discussion, when the switch passes the signal in the first format, i.e., the switch 604 couples the RF modulator circuitry 605 to connector 307, the master set top box 102 is in “analog mode” and, when the switch passes the signal in the second format, i.e., the switch 604 couples the MoCA circuit 609 to connector 307, the master set top 102 is in “digital mode”. It is to be appreciated that the switch 604 provides isolation between the RF modulation circuitry 605 and the other circuitry of the set top box 102, when in the analog mode. Furthermore, splitter 607 provides additional isolation when in the analog mode. By providing the set top box as configured in accordance with the teachings of the present disclosure, the RF modulated signal is isolated and separate from the satellite signal, since if included on one cable, the RF modulated signal may interfere with the satellite signal.

The RF modulated signal must be driven on its own coax cable and will interfere with the low level broadcast signals due to the “inexpensive construction” of the coax cable. The MoCA and other IEEE 802.15 signals can be driven on the same coax cable as low level broadcast signals due to their modulation schemes. Eventually, all/most analog TV's driven by an RF modulated system will need to be replaced. The satellite/cable service provider does not want to send out a new installer or to provide complicated instructions that will result in service calls. The switch 604 enables the MoCA or IEEE 802.15 signal to be “automatically” routed to the coax cable that was formerly carrying the RF modulated signal. Without it, new cable is needed or the customer must disconnect cables and add splitters (possibly causing signal issues for the low level broadcast signals and service calls).

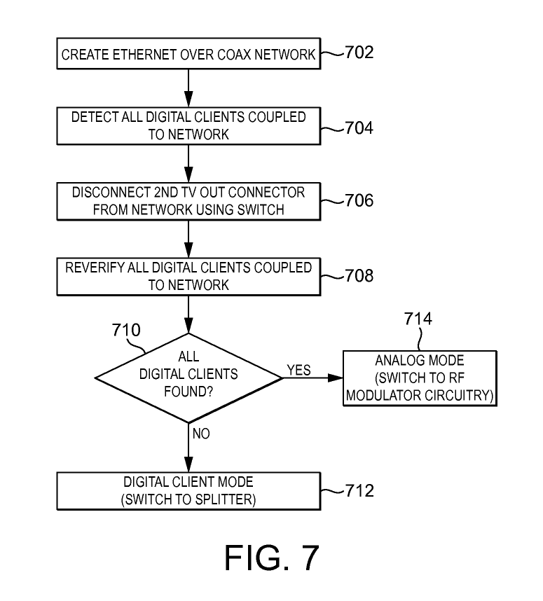

With reference to FIGS. 5, 6 and 7, a method for detecting a client device on a network will be described. Initially, in step 702, an Ethernet over coax network is created by coupling client set top box 420 to master set top box 102 via line 309. The line 309 is coupled to the audio/video output 307, e.g., a 2nd TV Out connector, on the master set top box 102. In step 704, the master set top box 704 detects all clients coupled to the network. It is to be appreciated that the recognition of the client set top box 420 by the master or gateway set top box 102 may be by autodiscovery in accordance with the Digital Living Network Alliance (DLNA) standard. For example, in the DLNA standard, Universal Plug and Play (UPnP) protocols are employed to assign an IP address to a new client device, via AutoIP as defined in the UPnP Device Architecture, and then, using Simple Service Discovery Protocol (SSDP), the new client device broadcasts its services to other devices on the network to be discovered by the other devices. However, other protocols may be employed.

Next, in step 706, the master set top box 102 positions switch 604 to the RF modulator circuitry 605 to remove the client set top box 420 from the network. Then, the master set top box 102 re-verifies all the client devices coupled to the network, step 708. In step 710, the master set top box 102 determines if all the client device were found. If the client set top box 420 is not found on the network, the master set top box 102 determines that the client set top box 420 was connected to the connector 307 and positions the switch 604 to the splitter 607, i.e., digital mode, step 712. Otherwise, if all the client devices were found, the master set top box 102 determines that an analog display device was coupled to connector 307 and positions the switch 604 to the RF modulator circuitry 605, i.e., analog mode, step 714.

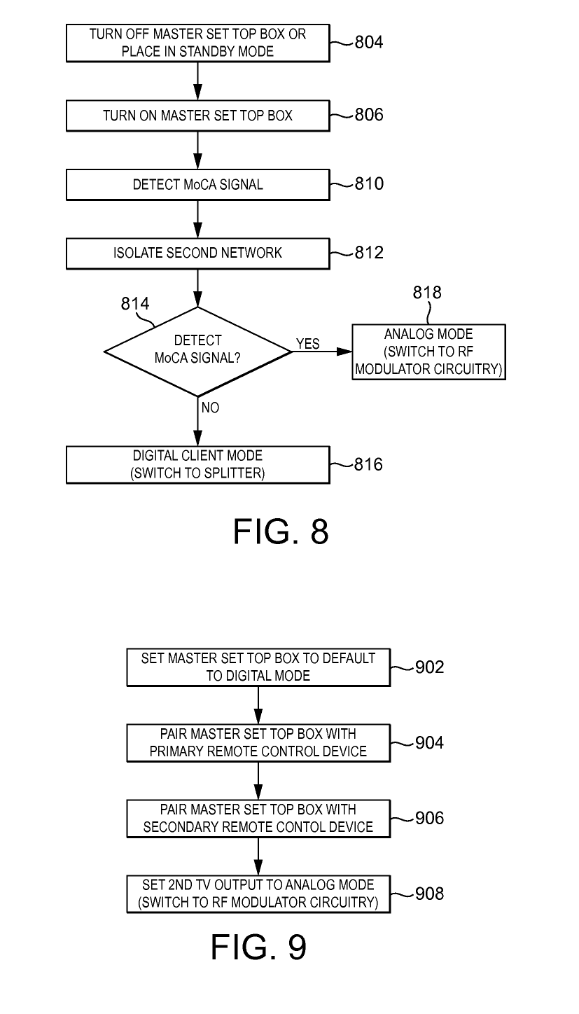

Once the master set top box 102 has set the mode of operation, i.e., analog mode or digital mode, the master set top box 102 can automatically switch modes to support upgrading or installation of a new client set top box. Referring to FIG. 8, the master set top box 102 determines if a client set top box is coupled to connector 307 by determining the presence of a MoCA signal. In step 804, the master set top box is turned off or placed in standby mode and subsequently turned on, in step 806. During the power on phase, the master set top box 102 detects or searches for the presence of a MoCA signal, in step 810. If a MoCA signal is received (e.g., from a client device), the master set top box 102 does not know if MoCA signal was from the main or first network 313 (i.e., with the satellite signal) or the second network 309 (i.e., the network that is used for the RF modulated signal). Presence of a MoCA signal on the second network 309 would be an indication of an “upgrade” from an analog TV to a digital TV with a client set top box. The controller 116 of the master set top box 102 then switches switch 604 to the analog mode or isolates the second network 309, step 812. Additionally, the controller 116 may also keep the modulator output from the RF modulator circuitry 605 turned off to prevent a false detection in the MoCA circuit 609. After the second network 309 is isolated from the master set top box 102, the controller 116 determines the presence or absence of a MoCA signal, step 814. If a MoCA signal is no longer received, the controller 116 determines that the signal originated on second network 309 and an upgrade to a digital client set top box has occurred. The controller 116 then set switch 605 to the digital mode and delivers the audio/video signal in a digital format, step 816. Operation on second network 309 for the RF modulated signal will be stopped. If MoCA signal still being received, the controller 116 determines that the signal was on main or first network 313 and operation of second network using RF modulated signal remains in use. The controller 116 then set switch 605 to the analog mode and delivers the audio/video signal in an analog format, step 818.

In other embodiment, a remote control device, such as remote control 200 and touch panel 220 may be employed to set the mode of the master set top box 102. In one embodiment, the master set top box 102 is set to digital mode as a default, for example, when sent to a user's residence or set at a manufacturing facility, step 902. In step 904, an installer (or end user) will pair a primary remote control with the master set top box 904. The 2^{nd} TV output 307 is defaulted to digital mode (or Ethernet over coax mode) via the switch 604. When the end user is ready to install the analog TV, e.g., television 316 shown in FIG. 3, to the 2^{nd} TV output connection 307, a second remote control device is paired to the master set top box 102. When the second remote control device is paired, the 2^{nd} TV output connection will automatically (or automatically prompt for a confirmation) change to RF modulated output, step 908. When pairing the second remote control device, the controller 116 generates a user interface on the analog television to prompt the user to confirm that an analog television is being used. A user interface will also ask which channel (frequency) to modulate the content onto. Subsequently, upon upgrading to a digital television, the user may employ the second remote control device to set the switch 604 of the master set top box 102 to the digital mode.

The embodiments above describe distribution of MoCA (Multimedia over Coax Alliance) or RF modulated audio/video signals on a single cable. The embodiments relate to operation in a home network system for distributing media content received on a central device (e.g., a gateway device) to one or more client devices over a co-axial cable using one of two possible signal formats. In a particular embodiment, a gateway device receives a satellite signal and is capable of distributing the signal either as a modulated analog or digital TV channel (e.g., channel ¾) or as a MoCA signal on a coaxial cable to one or more client boxes. Either or both of the gateway device and thin client device (both set top boxes with different features) may contain switching circuitry (either manual or automatic) that determines whether the signal is to be sent or has been received using one of the two formats. The gateway device may also be able to deliver the signal as a MoCA signal on a separate part of the home network to client devices, allowing the presence of both RF modulated signals on one part of the home network and MoCa signals on another part of the home network. The systems, apparatuses and methods of the present disclosure provide the ability to start a customer with a low cost solution for a second television display (possibly with no additional client set top box) and then provide an upgrade path to a better solution using the client set top box without having to perform a “truck roll” to the user's home.

It is to be appreciated that the various features shown and described are interchangeable, that is a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of a system, apparatus and method for distribution of MoCA or RF modulated audio/video on a single cable (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method comprising:
receiving a signal from a media service provider;
determining whether the signal is to be delivered using a first signal format or a second signal format through a co-axial cable;
providing the signal to a second device over the co-axial cable in the first signal format if it is determined that the signal is to be delivered using the first signal format; and
providing the signal to the second device over the co-axial cable in the second signal format if it is determined that the signal is to be delivered using the second signal format.

2. The method of claim 1, wherein the first signal format is at least one of an analog signal format and an RF modulated analog signal.

3. The method of claim 2, wherein the second signal format is at least one of a digital signal, an RF modulated Internet Protocol (IP) signal and a multimedia over cable alliance signal.

4. The method of claim 3, wherein the second signal format uses a signal frequency range that is different than the first signal format.

5. The method of claim 3, wherein the second signal format uses a signal frequency range that is substantially the same as the first signal format.

6. The method of claim 1, wherein the providing the signal in the first format further includes providing the signal to a television display device and wherein the providing the signal in the second format includes providing the signal to a set top box.

7. The method of claim 6, wherein the providing the signal to the set top box in the second signal format further includes providing the signal on at least one of a first network and a second network, the first network being different from the second network.

8. The method of claim 1, wherein the received signal is provided over a first network and the delivered signal is provided over a second network.

9. The method of claim 8, wherein the determining further includes:
detecting a presence of a second signal in the second signal format;
isolating the second network; and
if the second signal in the second signal format is detected after isolating the second network, providing the signal in the first signal format.

10. The method of claim 9, wherein if presence of the second signal is not detected after isolating the second network, providing the signal in the second signal format.

11. An apparatus comprising:
a signal interface that receives a signal from a media service provider;
a controller coupled to the first interface, the controller determining whether the signal is to be delivered using a first signal format or a second signal format; and
a switch coupled to the controller, the switch providing the signal to a second device in one of the first signal format and the second signal format based on the determination by the controller.

12. The apparatus of claim 1, wherein the first signal format is at least one of an analog signal format and an RF modulated analog signal.

13. The apparatus of claim 12, wherein the second signal format is at least one of a digital signal, an RF modulated Internet Protocol (IP) signal and a multimedia over cable alliance signal.

14. The apparatus of claim 13, wherein the second signal format uses a signal frequency range that is different than the first signal format.

15. The apparatus of claim 13, wherein the second signal format uses a signal frequency range that is substantially the same as the first signal format.

16. The apparatus of claim 11, wherein the switch provides the signal in the first signal format to a television display device and provides the signal in the second signal format to a set top box.

17. The apparatus of claim 16, wherein the signal provided in the second signal format to the set top box is provided on at least one of a first network and a second network, the first network being different than the second network.

18. The apparatus of claim 11, wherein the signal interface is coupled to a first network and the switch is coupled to a second network.

19. The apparatus of claim 18, wherein the controller further detects a presence of a second signal in the second signal format, isolates the second network via the switch and wherein the switch provides the signal in the first signal format if the presence of the second signal in the second signal format is detected after isolating the second network.

20. The apparatus of claim 19, wherein the switch provides the signal in the first signal format if presence of the second signal is not detected after the isolating the second network.

21. An apparatus comprising:
means for receiving a signal from a media service provider;
means for determining whether the signal is to be delivered using a first signal format or a second signal format; and
means for providing the signal to a second device in the first signal format if it is determined that the signal is to be delivered using the first signal format and providing the signal to the second device in the second signal format if it is determined that the signal is to be delivered using the second signal format.

22. The apparatus of claim 21, wherein the first signal format is at least one of an analog signal format and an RF modulated analog signal.

23. The apparatus of claim 22, wherein the second signal format is at least one of a digital signal, an RF modulated Internet Protocol (IP) signal and a multimedia over cable alliance signal.

24. The apparatus of claim 23, wherein the second signal format uses a signal frequency range that is different than the first signal format.

25. The apparatus of claim 23, wherein the second signal format uses a signal frequency range that is substantially the same as the first signal format.

26. The apparatus of claim 21, wherein the means for providing further includes means for providing the signal in the first signal format to a television display device and providing the signal in the second signal format to a set top box.

27. The apparatus of claim 26, wherein the means for providing the signal in the second signal format to the set top box further includes means for providing the signal on at least one of a first network and a second network, the first network being different from the second network.

28. The apparatus of claim 21, wherein the means for receiving received the signal over a first network and the means for providing provides the signal over a second network.

29. The apparatus of claim 28, wherein the means for determining further includes:
means for detecting a presence of a second signal in the second signal format;
means for isolating the second network; and
wherein the means for providing the signal further includes means for providing the signal in the first signal format if the presence of the second signal in the second signal format is detected after isolating the second network.

30. The apparatus of claim 29, wherein the means for providing the signal further includes means for providing the signal in the second signal format if the presence of the second signal in the second signal format is not detected after isolating the second network.
